(19) United States
(12) Patent Application Publication
(10) Pub. No.: US 2009/0129234 A1
(43) Pub. Date: May 21, 2009

(54) HOLOGRAM RECORDING DEVICE AND HOLOGRAM RECORDING METHOD

(75) Inventors: Kazushi Uno, Kawasaki (JP); Koichi Tezuka, Kawasaki (JP); Hiroyasu Yoshikawa, Kawasaki (JP); Yasumasa Iwamura, Kawasaki (JP); Yuzuru Yamakage, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/338,150

(22) Filed: Dec. 18, 2008

Related U.S. Application Data
(63) Continuation of application No. PCT/JP2006/312874, filed on Jun. 28, 2006.

(51) Int. Cl. G11B 7/00

(52) U.S. Cl. 369/103; G9B/7

(57) ABSTRACT

A hologram recording device illuminates with a recording beam (S) a hologram recording medium (B), and illuminates with a reference beam (R) a region illuminated with the recording beam (p) while variably controlling the incident angle regarding the hologram recording medium (B) whereby holograms are recorded on the illuminated region (p) in multiple by interference of the recording beam (S) and the reference beam (R). The device includes an incident angle variable controller for variably controlling the incident angle of the reference beam (R) in a predetermined range. The hologram recording medium (B) has such characteristics that its recording sensitivity degrades as the incoming light amount increases. The incident angle variable controller changes the incident angle of the reference beam (R) from a larger angle to a smaller angle.

This application is a Continuation of International Application Serial No. PCT/JP2006/312874, filed Jun. 28, 2006.

### TECHNICAL FIELD

The present invention relates to a hologram recording device that records holograms in multiple by an angle-multiplex recording method, and also to a hologram recording method.

### BACKGROUND ART

Patent document 1 discloses a conventional hologram recording method. According to the method disclosed in this document, a recording beam is impinges perpendicularly on the hologram recording medium, at the same time that a reference beam impinges on the region illuminated with the recording beam at different incident angles by controlling the inclination of a multiple mirror. Such method causes interference of the reference beam emitted at different incident angles and the recording beam emitted at a fixed incident angle on the illuminated region, so that various holograms are recorded in multiple according to the difference in incident angle. Here, although the holograms recorded in multiple are optically mixed on the illuminated region, as an analogy, the illuminated region is likened to a booklet, each of whose pages has a recorded hologram in the illuminated region. In this case, each of the pages corresponds to one of the incident angles of the reference beam.

Patent document 1: JP-A-2005-234145

The conventional hologram recording method bears, however, the following drawback because the process of changing the incident angle of the reference beam is not specifically taught.

As shown in FIG. 8, common hologram recording media have such a characteristic that the recording sensitivity degrades inversely proportional to the increase in amount of an impinging light. For example, the average recording sensitivity of the first recording page is approximately 6.50, while the recording sensitivity of the last recording page is approximately 1.167, under the condition of the diffraction efficiency η and so on. On the assumption that the light intensity for recording in each page is constant, and the recording is performed in the case where the incident light amount obtained by time-integration of the constant light intensity reaches the level corresponding to the recording sensitivity, the duration of illumination for the last recording page becomes approximately 6.5 times as long as that for the first recording page.

On the other hand, the incident angles of the reference beam is changed according to the angle-multiplex recording process when the holograms are recorded on each page, and the light intensity is decreased as the incident angle is increased, based on the illuminance cosine law. Accordingly, in the case, for example, where the incident angle of the reference beam is increased from a smaller angle to a larger angle, the recording sensitivity and the light intensity are both lowered, and hence the duration of illumination has to be gradually extended in consideration of also the decrease in light intensity. In the case of gradually increasing the incident angle of the reference beam, therefore, the duration of illumination becomes significantly longer with the increase in number of recording pages, which impedes achieving a notable increase in recording speed.

### DISCLOSURE OF THE INVENTION

The present invention has been proposed under the foregoing situation. An object of the present invention is to provide a hologram recording device and a hologram recording method that allow significantly increasing the recording speed when performing the multiple recording.

To achieve the foregoing object, the present invention takes the following technical measures.

A first aspect of the present invention provides a hologram recording device that illuminates, with a recording beam, a hologram recording medium having such characteristics that its recording sensitivity degrades as the incoming light amount increases, while also illuminating, with a reference beam, the region (target site) illuminated with the recording beam while variably controlling the incident angle of the reference beam with respect to the hologram recording medium. As a result, holograms are recorded at the target site in multiple by interference of the recording beam and the reference beam. The hologram recording device comprises an incident angle variable controller for variably controlling the incident angle of the reference beam in a predetermined angle range, changing the angle from a larger angle to a smaller angle.

Preferably, the hologram recording device may further comprise an illumination duration controller for controlling the duration time of illumination by the recording beam and the reference beam, where this control is performed each time the incident angle of the reference beam is changed. The illumination duration controller controls the duration of illumination based on light intensity changed in accordance with the incident angle of the reference beam, so that the incident light amount obtained by time integration of the light intensity will reach a level corresponding to the recording sensitivity.

A second aspect of the present invention provides a hologram recording method for a hologram recording medium whose recording sensitivity degrades as an incoming light amount increases. The method comprises: illuminating a target site of the hologram recording medium with a recording beam; illuminating the target site with a reference beam while variably controlling an incident angle of the reference beam with respect to the hologram recording medium; and recording holograms at the target site in multiple by interference of the recording beam and the reference beam. The incident angle of the reference beam is variably controlled to change in a predetermined angle range from a larger angle to a smaller angle for the multiple hologram recording at the target site.

### BRIEF DESCRIPTION OF THE DRAWINGS

FIG. 1 is a perspective view showing a hologram recording device according to an embodiment of the present invention;

FIG. 2 is a fragmentary cross-sectional view of the hologram recording device shown in FIG. 1;

FIG. 3 is a graph for explaining the optical effect of the hologram recording device shown in FIG. 1;

FIG. 4 is another graph for explaining the optical effect of the hologram recording device shown in FIG. 1;

FIG. 5 is still another graph for explaining the optical effect of the hologram recording device shown in FIG. 1;

FIG. 6 is a graph for explaining the optical effect based on a comparative example;

FIG. 7 is a graph for explaining a difference in optical effect between the hologram recording device shown in FIG. 1 and the comparative example; and

FIG. 8 is a graph for explaining a recording characteristic of a conventional hologram recording medium.

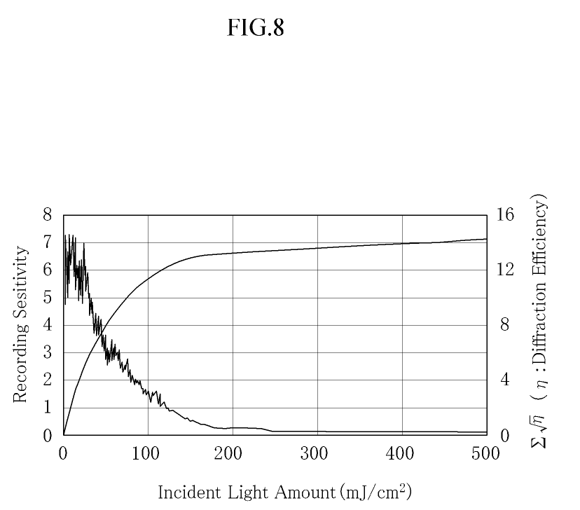

### BEST MODE FOR CARRYING OUT THE INVENTION

A preferred embodiment of the present invention will be described below in details, referring to the drawings.

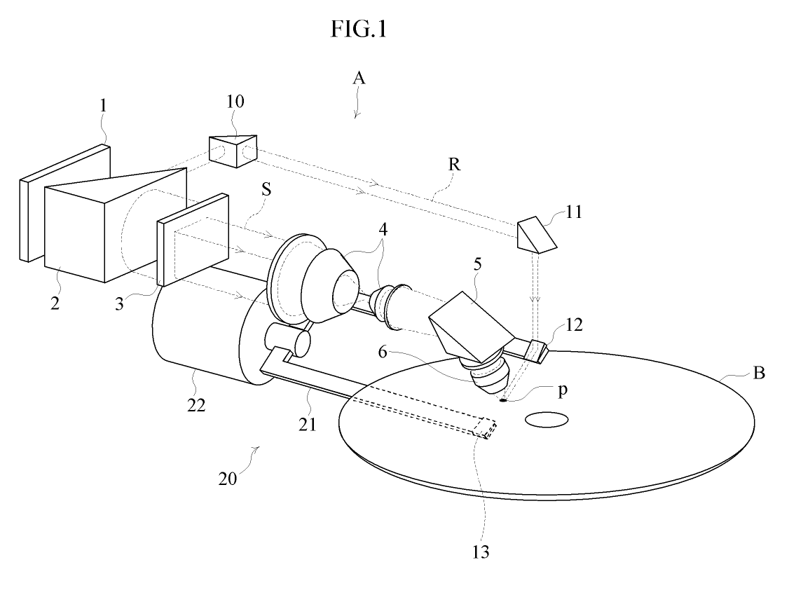

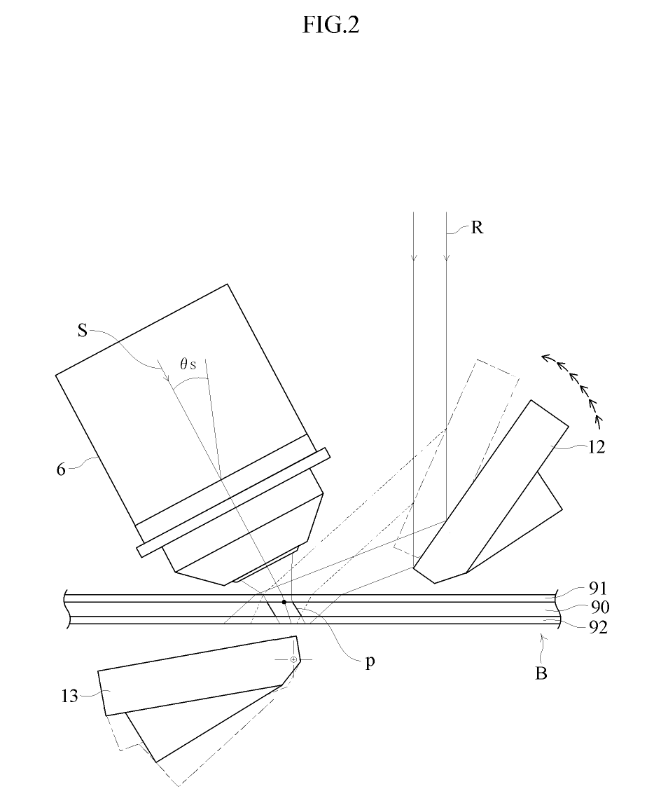

Referring to FIG. 1, a hologram recording device A according to the embodiment emits a recording beam S to a disk-shaped hologram recording medium B in a manner such that the primary beam of the recording beam S is inclined in a predetermined direction that defines a fixed incident angle θs (Ref. FIG. 2), and emits a reference beam R to a region p illuminated with the recording beam S in a manner such that the reference beam in inclined in a direction opposite to the direction of the recording beam S while variably controlling the incident angle, whereby holograms are recorded in multiple by interference of the recording beam S and the reference beam R.

The hologram recording device A includes an optical shutter that controls duration of illumination (duration of illumination controller) 1, a beam splitter 2 that splits light into the recording beam S and the reference beam R, an recording beam optical system that serves to emit the recording beam S to the hologram recording medium B, and a reference beam optical system that serves to emit the reference beam R to the hologram recording medium B while variably controlling the incident angle. Though not shown, the hologram recording device A includes a light source that emits a laser beam, and a collimator lens that converts the laser beam into parallel light. The recording beam optical system includes a spatial light modulator 3, a zoom lens 4, a half mirror 5, and an objective lens 6 for the recording beam. The reference beam optical system includes fixed mirrors 10, 11, recording and reproduction mirrors 12, 13, and an incident angle variable controller 20 that causes the recording and reproduction mirror 12, 13 to integrally swing so as to variably control the incident angle of the reference beam R. The incident angle variable controller 20 includes a U-shaped arm member 21 and a driving motor 22. The recording mirror 12 is fixed to an end portion of the arm member 21 located above the hologram recording medium B. The reproduction mirror 13 is fixed to the other end portion of the arm member 21 located below the hologram recording medium B. The optical shutter 1, the beam splitter 2, the recording beam optical system and the reference beam optical system are mounted on a movable head (not shown) which is able to reciprocate radially of the hologram recording medium B.

As shown in FIG. 2, the hologram recording medium B includes as the intermediate layer a recording layer 90 constituted of, for example, a photopolymer, and light-transmitting cover layers 91, 92 stacked on the respective sides of the recording layer 90. Similarly to the conventional ones, the recording layer 90 has such a characteristic that the recording sensitivity degrades inversely proportional to the increase in incident light amount. In this embodiment, for example, the recording layer 90 has a thickness of approximately 1 mm, and the cover layers 91, 92 has a thickness of approximately 0.5 mm. In a recording process, the recording beam S and the reference beam R are emitted from above the hologram recording medium B. In a reproduction process, only the reference beam R is emitted from below the hologram recording medium B.

The laser beam emitted by the light source which is not illustrated in the drawings is converted into parallel light by the collimator lens which is not illustrated, and then reaches the beam splitter 2 via the optical shutter 1. The optical shutter 1 transmits/blocks the light by on-and-off control. The optical shutter 1 allows controlling the duration time of the illumination of the hologram recording medium B with the recording beam S and the reference beam R, which pass through the optical shutter 1. The laser beam reaching the beam splitter 2 is split into the recording beam S and the reference beam R. In a recording process, for example, the recording beam S is led to the spatial light modulator 3, while the reference beam R is led to the recording mirror 12 via the fixed mirrors 10, 11.

The spatial light modulator 3 is constituted of a transmissive liquid crystal device for example, and converts the recording beam S reaching the spatial light modulator 3 into light representing two-dimensional pixel pattern according to the information to be recorded. The recording beam S emitted from the spatial light modulator 3 is led to the half mirror 5 via the zoom lens 4, to finally impinge on the hologram recording medium B after being converted into parallel light for each pixel by the objective lens 6 for the recording beam. As shown in FIG. 2, the objective lens 6 is arranged such that the optical axis of the objective lens 6 defines a fixed incident angle θs with respect to the hologram recording medium B. Here, although the light corresponding to each pixel emitted from the spatial light modulator 3 illuminates the hologram recording medium B at a respectively different incident angle via the objective lens 6, it will be assumed herein that a pixel having a primary beam that coincides with the optical axis of the objective lens 6 exists, which defines the fixed incident angle θs with respect to the hologram recording medium B, and the primary beam coinciding with the optical axis will be referred to as the primary beam of the recording beam S. In this embodiment, the incident angle θs of the recording beam S is set at 35 degrees as an example. The region p illuminated with the recording beam S forms a parallelogrammic exposure region on the recording layer 90 in a cross-sectional view as shown in FIG. 2, when focusing on a beam corresponding to a given pixel. FIG. 2 shows the parallelogrammic exposure region presenting its maximum width.

As shown in FIG. 2, the recording and reproduction mirror 12, 13 are caused to swing about a predetermined axis x in an integrated manner with the arm 21. The recording mirror 12 is located close to the objective lens 6 for the recording beam and obliquely above the illuminated region p, so as to reflect the reference beam R, which has advanced from the fixed mirror 11 generally perpendicularly to the hologram recording medium B, obliquely downward toward the illuminated region p. The reproduction mirror 13 is located obliquely below the illuminated region p, and opposite with respect to the hologram recording medium B to the objective lens 6 for the recording beam, so as to reflect the reference beam R, which has advanced generally parallel to the hologram recording medium B, obliquely upward toward the illuminated region p. Here, a galvano mirror may be employed as the recording or reproduction mirror. The beam corresponding to each pixel does not have to be converted into parallel light by the objective lens 6, and may be converted into converging light. In the case of the converging light, the light is not turned into parallel light in the hologram recording medium B, but converted into the converging light having a relatively small convergence angle, by the objective lens 6.

In FIG. 2, the solid lines depict the recording and reproduction mirror 12, 13 in a state where the incident angle of the reference beam R is the maximum. The incident angle of the reference beam R under such state is, for example, 75 degrees. In the recording process in particular, the recording mirror 12 is made to swing counterclockwise step by step of a predetermined angle in a predetermined angular range. The recording mirror 12 is temporarily held at each desired angle, and the optical shutter 1 is turned on under each of such state to thereby transmit the laser beam. Thus, the recording beam S and the reference beam R simultaneously impinge on the illuminated region p, so that a hologram is recorded on each page according to the incident angle of the reference beam R. The on-state time period of the optical shutter 1 is controlled with respect to each page. Accordingly, the recording beam S and the reference beam R are controlled so as to be emitted for a different duration of time to each page. While the recording mirror 12 is rotated to a subsequent stop position, the optical shutter 1 is turned off so as to block the recording beam S and the reference beam R. In other words, the recording mirror 12 is rotationally displaced from the position indicated by solid lines to the position indicated by imaginary lines, so that the incident angle of the reference beam R is decreased by predetermined angles from 75 degrees to 50 degrees, for example. Once the holograms are recorded in multiple on a given illuminated region p, the optical shutter 1 is turned off to thereby block the recording beam S and the reference beam R while the recording mirror 12 is returned to the initial position where the incident angle of the reference beam R becomes smallest (indicated by imaginary lines).

Next, the optical functions of the hologram recording device A will be described below.

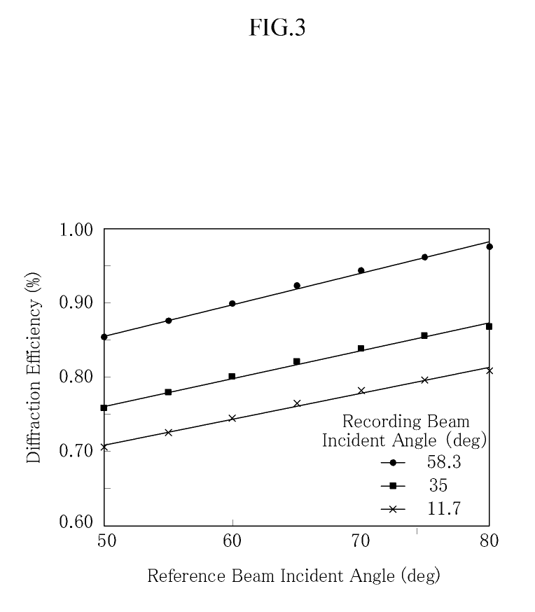

As shown in FIG. 2, the recording beam S impinges on the illuminated region p in a manner such that the incident angle θs of the primary beam becomes 35 degrees. Meanwhile, a portion of the recording beam S passing through the vicinity of the periphery of the objective lens 6 includes a luminous flux that defines, unlike the incident angle θs of the primary beam, for example an incident angle of 11.7 degrees and 58.3 degrees. In the case where the incident angle of the reference beam R is changed from 50 degrees to 80 degrees while the incident angle of the recording beam S at 11.7 degrees, 35 degrees, and 58.3 degrees, the diffraction efficiency changes in a tendency shown in FIG. 3. For example, the diffraction efficiency in a case where the incident angle of the reference beam R is 75 degrees is approximately 13% greater than that in a case where the incident angle of the reference beam R is 50 degrees, irrespective of the incident angle of the recording beam S. Such increase in diffraction efficiency can be considered as a factor that contributes to reducing the recording time.

The reference beam R is controlled in a manner such that the incident angle is gradually decreased from 75 degrees to 50 degrees. In this case, the recording beam S is emitted onto the illuminated region p so as to defocus the Fourier image. Also, when the incident angle of the reference beam R is 50 degrees, the beam splitter 2 and the spatial light modulator 3 split light into the reference beam R and the recording beam S and control the intensity of them so that a ratio of Ir:Is constantly becomes 3:1, where the light intensity of the reference beam R and the recording beam S on the illuminated region p (luminous flux per unit area) is respectively denoted by Ir and Is. By thus setting the light intensity ratio at Ir:Is, the holograms are recorded in a desirable contrast on the illuminated region p.

On the other hand, the illumination width of the reference beam R around illuminated region p is expanded to approximately 2.484 times when the incident angle is 75 degrees (indicated by solid lines), compared to the case where the incident angle is 50 degrees (indicated by broken lines), according to the illuminance cosine law. The increase in illumination width leads to a decrease in light intensity. Therefore, when the incident angle of the reference beam R is decreased from 75 degrees to 50 degrees with the light intensity Ir of the reference beam R before reaching the recording mirror 12 being constant, the light intensity Ir of the reference beam R is gradually increased as the illumination width is reduced.

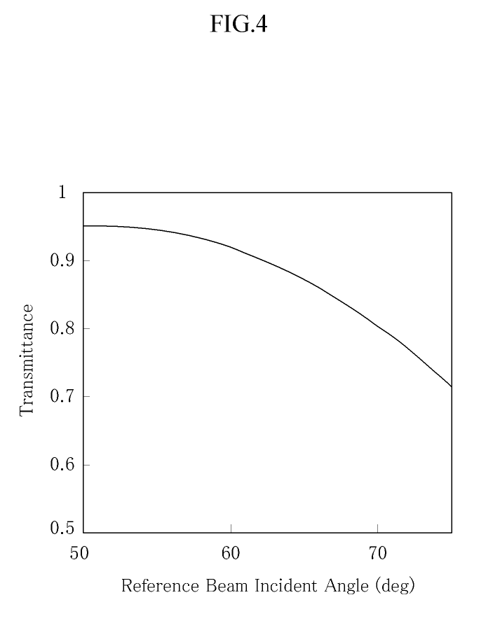

The transmittance T of the reference beam R at the illuminated region p degrades as the incident angle increases, as shown in FIG. 4. Since the relation Ir:Is=3:1 is established regarding the light intensity ratio of the reference beam R and the recording beam S in the case where the incident angle of the reference beam R is 50 degrees on the assumption that the transmittance T at the incident angle of 50 degrees is 1 and the light intensity Ir, Is of the reference beam R and the recording beam S as P, 1−P respectively, the light intensity of the reference beam R becomes 0.75, and the light intensity of the recording beam S becomes 0.25.

Meanwhile, when compared with the reference beam R being emitted at the incident angle of 50 degrees, the transmittance T at the incident angle of 75 degrees becomes approximately 0.75. Also, at the incident angle 75 of degrees, the light intensity Ir of the reference beam R becomes 1/2.484 times as intense compared with the case where the incident angle is 50 degrees. Accordingly, regarding the light intensity ratio of the reference beam R and the recording beam S in the case where the incident angle of the reference beam R is 75 degrees, since the relation Ir:Is=T·P/2.484:1−P=3:1 is established, the light intensity of the reference beam R becomes 0.275, and the light intensity of the recording beam S becomes 0.092.

On the assumption that the diffraction efficiency ratio is employed as a parameter while the recording sensitivity of the hologram recording medium B at the start of the recording is 6.50, the recording sensitivity at the end of the recording is 1.167, the light intensity of the recording beam S is Is, and the diffraction efficiency at the incident angle of 50 degrees is 1, the recording time of each page required when the incident angle of the reference beam R is changed from 75 degrees to 50 degrees is specified as follows. It should be noted that the recording time for each page will be inversely proportional to the light intensity Is, the recording sensitivity, and the diffraction efficiency ratio, and hence defined as 1÷Is÷recording sensitivity diffraction efficiency ratio. The value obtained by multiplying the recording time and the light intensity corresponds to the incident light amount, and it will be assumed that the recording is performed when the incident light amount reaches the level that meets the recording sensitivity.

(In the case where the incident angle of the reference beam R is 75 degrees at the start of the recording)

Recording time of the first recording page=1.480

(In the case where the incident angle of the reference beam R is 50 degrees at the end of the recording)

Recording time of the last recording page=3.428

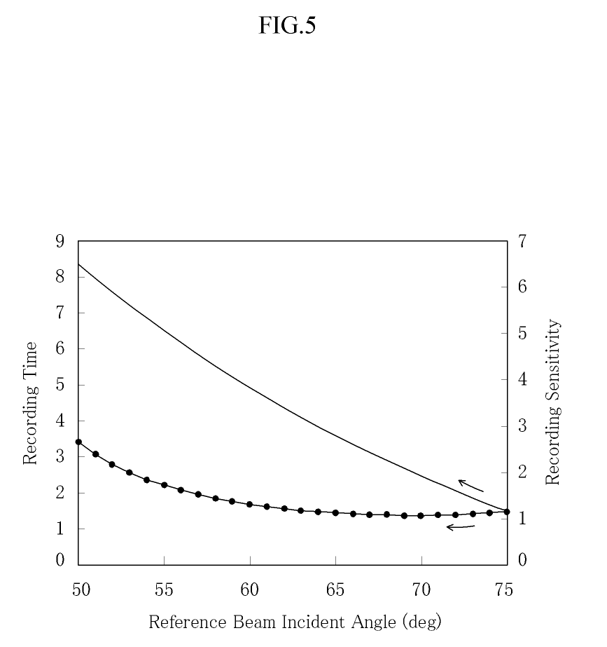

In the case where the incident angle of the reference beam R is decreased from 75 degrees to 50 degrees as in this embodiment, the page recording time and the recording sensitivity are changed as shown in FIG. 5. The total recording time of all the pages in the case of decreasing the incident angle from 75 degrees to 50 degrees can be obtained by integration of the curve representing the page recording time (curve formed by plotting the times) with the incident angle. In the figure, the total recording time of all the pages corresponds to the area of the region surrounded by the curve indicating the page recording time and the horizontal axis.

Contrary to the above, the recording time per page in the case of increasing the incident angle of the reference beam R from 50 degrees to 75 degrees is indicated below as a comparative example.

(In the case where the incident angle of the reference beam R is 50 degrees at the start of the recording)

Recording time of the first recording page=0.615

(In the case where the incident angle of the reference beam R is 75 degrees at the end of the recording)

Recording time of the last recording page=8.243

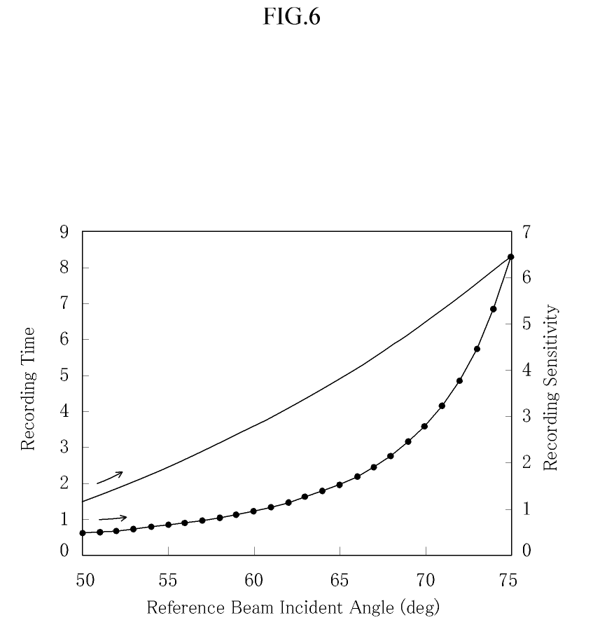

In the case of increasing the incident angle of the reference beam R from 50 degrees to 75 degrees, the page recording time and the recording sensitivity are changed as shown in FIG. 6. Upon comparing the FIGS. 5 and 6, it is apparent that the total recording time of all the pages according to this embodiment is shorter than that in the comparative example. Through actual integration of the total recording time of all the pages, the recording time according to this embodiment is shortened by a ratio of approximately 0.77 with respect to the comparative example.

With the hologram recording device A according to this embodiment, therefore, by gradually decreasing the incident angle of the reference beam R from a larger angle to a smaller angle, light intensity is increased gradually though the recording sensitivity is lowered, thereby minimizing the need to largely extend the recording time per page and thus facilitating significantly increasing the recording speed by shortening the total recording time of all the pages.

Next, description will be given below regarding ineffective exposure occurring at the periphery of the illuminated region p.

At the periphery of the illuminated region p, there is a region which is illuminated only by the reference beam R. The area of such a “void exposure region” becomes larger as the incident angle of the reference beam R increases in accordance with the illuminance cosine law.

Here, it is assumed that the illumination area of the reference beam R at the incident angle of 50 degrees is 1.1, and the illumination area of the recording beam S is 1. In other words, it is assumed that 10% of void exposure region is formed when the incident angle is 50 degrees. Based on this assumption, the coefficient of void exposure (or void exposure coefficient) can be defined as follows.

Specifically, the void exposure coefficient is defined based on the light intensity Ir of the reference beam, the ratio of the void exposure region with respect to the illumination area of the reference beam R, and the recording time per page employed as parameters, and described as Ir×void exposure region ratio×recording time per page. In the case where the incident angle is changed from 75 degrees to 50 degrees, the void exposure coefficient is worked out as follows.

(In the case where the incident angle of the reference beam R is 75 degrees at the start of the recording)

Light intensity Ir of the reference beam=0.275

Recording time per page=1.480

Ratio of the void exposure region=158%

Void exposure coefficient=0.643

(In the case where the incident angle of the reference beam R is 50 degrees at the end of the recording)

Light intensity Ir of the reference beam=0.75

Recording time per page=3.428

Ratio of the void exposure region=10%

Void exposure coefficient=0.257

The void exposure coefficient in the case of increasing the incident angle of the reference beam R from 50 degrees to 75 degrees is given below as a comparative example.

(In the case where the incident angle of the reference beam R is 50 degrees at the start of the recording)

Light intensity Ir of the reference beam=0.75

Recording time per page=0.615

Ratio of the void exposure region=10%

Void exposure coefficient=0.0461

(In the case where the incident angle of the reference beam R is 75 degrees at the end of the recording)

Light intensity Ir of the reference beam=0.275

Recording time per page=8.243

Ratio of the void exposure region=158%

Void exposure coefficient=3.582

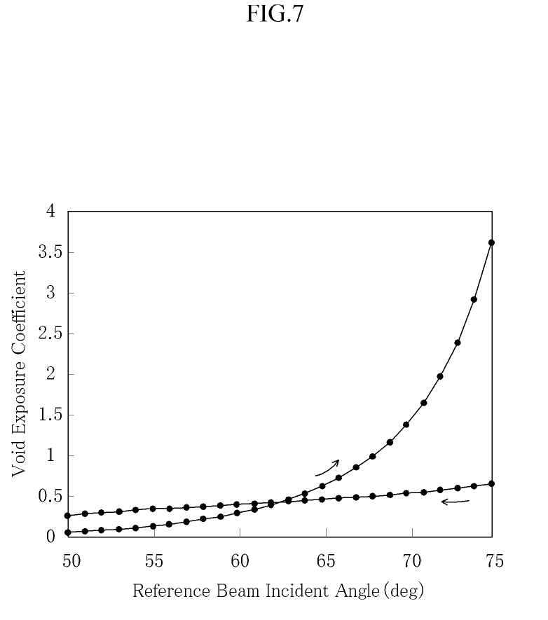

FIG. 7 shows the transition of the void exposure coefficient in the case of decreasing the incident angle from 75 degrees to 50 degrees, and the transition of the void exposure coefficient in the case of inversely increasing the incident angle from 50 degrees to 75 degrees. It can be understood that the void exposure coefficient is involved with the recording capacity per page, so that an increase in void exposure coefficient leads to reduction in recording capacity. Upon comparison of the void exposure coefficient referring to FIG. 7 between the cases of decreasing the incident angle from 75 degrees to 50 degrees and increasing the incident angle from 50 degrees to 75 degrees, it is understood that the void exposure coefficient of all the pages obtained through integration with the incident angle in the case of increasing the incident angle from 50 degrees to 75 degrees becomes approximately 1.92 times of the case of decreasing the incident angle from 75 degrees to 50 degrees.

Therefore, the hologram recording device A according to this embodiment, thus set to gradually decrease the incident angle of the reference beam R from a larger angle to a smaller angle, is more advantageous also in the aspect of the recording capacity and provides a significantly larger recording capacity.

It is to be understood that the present invention is not limited to the foregoing embodiment.

The numerical values cited with reference to the foregoing embodiment are merely exemplary, and may be appropriately modified according to the desired specification.

1. A hologram recording device used for a hologram recording medium whose recording sensitivity degrades as an incoming light amount increases, the device being configured to illuminate a target site of the hologram recording medium with a recording beam and also to illuminate the target site with a reference beam while variably controlling an incident angle of the reference beam with respect to the hologram recording medium, whereby holograms are recorded on the target site in multiple by interference of the recording beam and the reference beam, the hologram recording device comprising:
an incident angle variable controller for variably controlling the incident angle of the reference beam in a predetermined angle range, the incident angle variable controller changing the incident angle of the reference beam from a larger angle to a smaller angle.

2. The hologram recording device according to claim 1, further comprising an illumination duration controller for controlling a duration of illumination of the recording beam and the reference beam each time the incident angle of the reference beam is changed, wherein the illumination duration controller controls the duration of illumination based on light intensity changed in accordance with the incident angle of the reference beam, so that an incident light amount obtained by time integration of the light intensity reaches a level corresponding to the recording sensitivity.

3. A hologram recording method for a hologram recording medium whose recording sensitivity degrades as an incoming light amount increases, the method comprising: illuminating a target site of the hologram recording medium with a recording beam; illuminating the target site with a reference beam while variably controlling an incident angle of the reference beam with respect to the hologram recording medium; and recording holograms at the target site in multiple by interference of the recording beam and the reference beam;
wherein the incident angle of the reference beam is variably controlled to change in a predetermined angle range from a larger angle to a smaller angle for the multiple hologram recording at the target site.
